(19) United States
(12) Patent Application Publication
(10) Pub. No.: US 2002/0161791 A1
(43) Pub. Date: Oct. 31, 2002

(54) Method and equipment for the use of a distributed database and the application utilizing the database independently from the terminal

(76) Inventor: Sami Hanhikoski, Jyvaskyla (FI)

Correspondence Address: SMITH, GAMBRELL & RUSSELL, LLP, 1850 M STREET, N.W., SUITE 800, WASHINGTON, DC, 20036, US

(21) Appl. No.: 10/116,127

(22) Filed: Apr. 5, 2002

(30) Foreign Application Priority Data
Apr. 6, 2001 (FI) 20010724

(51) Int. Cl. G06F 17/30

(52) U.S. Cl. 707/205

(57) ABSTRACT

A method that enables the use of distributed database and the application utilizing it independently from the terminal or the type of the terminal. The information of the distributed database (303, 305, 403, 405,407) is used in the terminal (301, 401) in a way that the local database (303, 403) is processed with the help of the management unit. (306,406). The query results gained from the local database (303, 403) are transmitted via the management unit (306, 406) to the browser application (302, 402) of the terminal (301, 401). With the help of the terminal's (301, 401) browser application (302, 402) the query results are presented to the user.

### INTRODUCTION AND BACKGROUND

This invention concerns a method and equipment with the help of which a distributed database and the application utilizing the database can be used independently from the terminal and the terminal type.

Distributed databases and especially the synchronization of the changed data related to them have been traditionally considered difficult and risky.

Because of this, one has avoided using distributed databases and has instead used a centralized database with the appropriate terminal connections.

FIG. 1 presents a solution that is in accordance with a well-known technical solution, in which the data is stored and saved using a centralized database.

Terminal 101 makes a query, which will be directed to the management system 102.

Database management interface 102 retrieves the information returned by the query from the database 103.

The information found is returned from database 103 via a management interface in 102 to the querying terminal 101.

In this kind of solution the requesting terminal 101 has to have some type of a connection to the database management interface 102.

If the terminal 101 is out of reach of a certain network connection, the data cannot be retrieved.

Naturally, there are known technical implementations of distributed databases and methods for using them.

FIG. 2 presents a distributed database.

In the solution presented in FIG. 2, the database management interface 202 is integrated into the terminal 201. Due to this the connection between those does not have to be established separately.

The database management interface 202 communicates with the local database 203 and is able to use a local connection to retrieve data.

At the simplest the local database 203 and the management interface 202 are both integrated into the terminal 201.

On the other hand, the local database 203 can locate in a local area network. In this case there is a local area network connection between the database management interface 202 and the terminal 201 or between the database management interface 202 and local database 203.

The local database 203 is from time to time connected to the server database 205.

The data in these two databases 203 and 205 is updated by some known synchronization method 204.

These synchronization functions 204 can be handled e.g. with a known method released by Oracle corporation or with a server-client pair known from the SyncML-protocol released by SyncML-consortium.

The synchronization of databases guarantees, that the data in both databases is consistent and especially that the latest information will be updated, regardless of whichever database it was inserted or updated to.

In the method described in FIG. 2, the terminal 201 has to be able to use the information retrieved from the database.

In practice, the application, which takes into consideration the terminal type, has to be stored to the terminal. This way the data can be presented to the user in a most intelligible way, taken into consideration the physical properties of the user interface integrated to the terminal type.

Additionally, without thorough re-programming, one terminal can be used to present only the kind of data it was originally designed for.

### SUMMARY OF THE INVENTION

It is an object of this invention is to present a method and equipment, which enables the utilization of the data retrieved from the database independently from the type of the terminal.

Another object of the invention is to present a method and equipment which enables the flexible usage of a distributed database.

Furthermore, an object of the invention is to present a system that utilizes a distributed database and can be easily modified for different kind of purposes.

According to the invention, either in the terminal or in its close proximity there is a local database and a management unit meant to utilize it. The management unit transmits the queries to the database and processes the results received from the database.

However, the invention does not presume that the management unit is able to directly present information to the user through the user interface, or to receive commands from the user via the user interface of the terminal.

For this purpose there is a browser in the terminal, that can process pages represented with a certain standardized method, which on the priority date of this patent application are typically HTML-pages.

The browser application is also tailor-made to be compatible with the terminal's physical user interface. Using the functionalities of this physical user interface a conventional TCP/IP-connection can be established to the desired network.

The software user interface of the equipment in accordance with the invention is composed of a group of HTML-pages stored locally in the terminal. These pages can be loaded to the display of the terminal with the browser-application.

These pages to be presented include sections that are not meant to be understood by the browser-application, but to tell the database management unit which function related to the database management these sections relate to.

On the priority date of the patent application the sections mentioned are SQL (Structured Query Language)-queries. These queries can be separated from the rest of the page description with separating characters, also known as tags.

When a user wants to query information through the page he sees, he will present the request by e.g. keying in the information used as a search key to a search field and clicking a press-button <RETRIEVE>.

The information of the request will be transmitted to the database management unit, which knows what kind of (SQL)-query is related to that particular part of the (HTML)-page.

The database management unit transmits the query and the information possibly given by the user to the database.

The result of the query will be received by the management unit, which can transmit it according to the original HTML/SQL-language page to the browser application in a way that the results can be presented in the right place in the terminal's user interface as clear, in this case HTML-language data.

This data can be retrieved in principle from whichever SQL-based database or from a database in accordance with the predetermined format.

### BRIEF DESCRIPTION OF THE DRAWING

The present invention will be further understood with reference to the accompanying drawings, wherein:

FIG. 1 illustrates a system based on known technology;

FIG. 2 illustrates another system based on known technology;

FIG. 3 illustrates a system according the to the invention;

FIG. 4 illustrates a system that is based on another method of the invention;

FIG. 5a illustrates a function based on one of the invention's methods; and

FIG. 5b illustrates a function that is based on invention's other method.

### DETAILED DESCRIPTION OF THE INVENTION

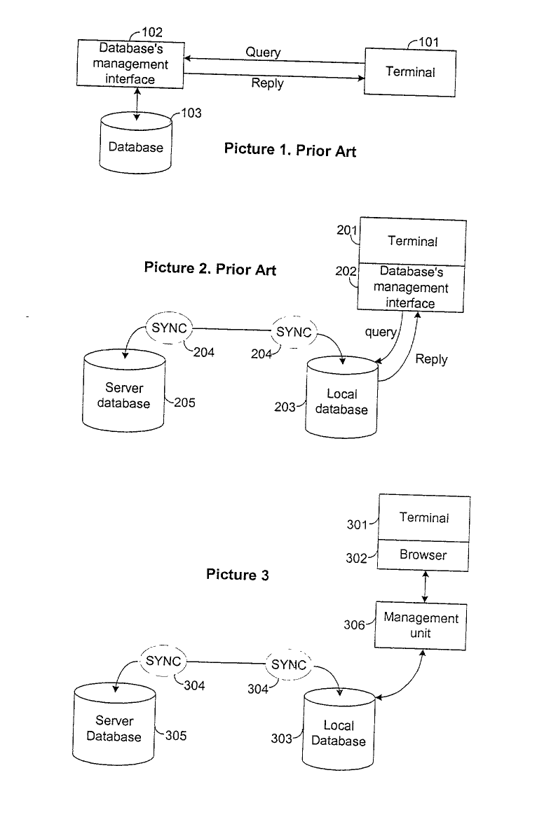

FIGS. 1 and 2 have already been explained in the known technical description.

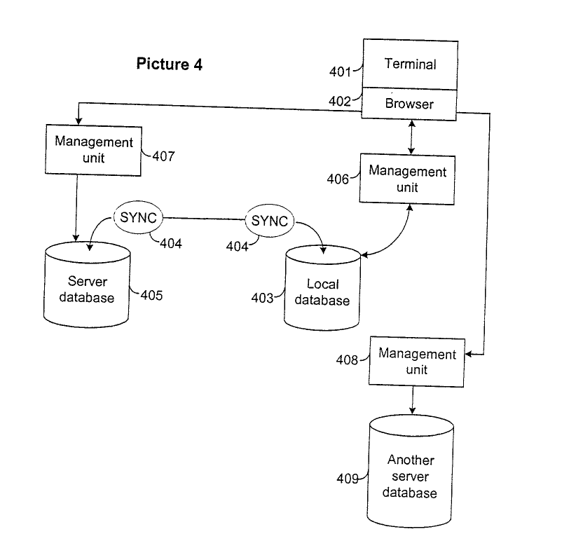

In FIG. 3 there is one solution based on the invention's method, in which the terminal 301 is connected to a local database 303 through management unit 306.

In the terminal there is the browser application 302, the purpose of which is to present HTML-pages formatted to the terminal on its display. The browser application also provides the user a possibility to give commands and other input data concerning certain points of (HTML-) pages and to organize the formation of data transmission connections and their controlled maintenance via a physical network connection to the network, from which it is possible to upload (HTML-) pages.

The terminal's physical user interfaces have not been standardized in any way, so e.g. the sizes and resolutions vary a lot.

In the same way there can be keyboard, mouse, limited group of control keys, guide roller, touch pen, joystick, voice control or some other kind of device or a combination of these kinds of devices.

In practice the manufacturer of the terminal usually provides a tailor-made browser with the terminal. This browser can transmit and receive information from the network using a certain standardized network protocol. (e.g. HTTP+TCP/IP); HyperText Transfer Protocol+Transmission Control Protocol/Internet protocol).

The browser is able to take the special features of the display and the data input devices into consideration.

At this point it is mainly presumed that the browser is able to show the page on the display using a language typically used for this purpose and to receive input data, which is related to the particular sections of this kind of a page.

These pages have been produced using some structured language, HMTL-language or XML-language for example.

The possibility to separate the structure of the language from the actual content is essential, so that the structural sections can be handled in desired way.

The software user interface means the electrically stored information that controls what will be presented to the user and how the user is able to give input data.

In FIG. 3 the software user interface of distributed database systems is composed of a group of pages to be shown in on the display. These pages are produced with a predetermined, structured language.

In this example the pages have been produced in HTML-language.

These HTML-pages can be designed to a certain appearance and content, e.g. for all employees of some company.

In addition, or instead of this, the software user interface composed of HMTL-pages can be modified according to wishes of each user.

Certain properties and functions included in these HTML-pages are a part of the software user interface.

When a user wishes to retrieve the instructions for a certain job or information about one of his customers, he can present the request to his terminal 301 by keying in the necessary search phrases to the fields that are a part of certain HTML-page. The browser then presents them in the terminal screen under the circumstances.

The browser 302 reacts to this given input data like it would receive a request to retrieve certain content from a certain source: the interface from the browser to the management unit 306 in this matter acts in the same way as known interfaces from the browser to known data sources.

The request that contains the search phrases and/or other input information is transmitted to the management unit 306. The management unit retrieves the query code, which can be in SQL-language, and attaches possible search phrases given by the user to it.

In this case this produces an SQL-language query, which the management unit 306 transmits to the database 303.

Information can be queried from databases to which the user has privileges and which can be handled by the management units.

The database 303 transmits the query results to the management unit 306.

Now the task of the management unit 306 is to outline the results so that they can be delivered to the browser 302, which furthermore presents the results to the user in the terminals 301 screen.

The results of the query are therefore located in the right section of the user's display in a predefined order and format.

Many advantages are gained by using a browser.

The browser is usually pre-installed or at least easily installable to all appropriate terminal types.

The usage of browsers will become more common when almost any terminal will be equipped with Internet-connection.

The manufacturers of the terminals plan to tailor-make the browsers suitable to each terminal type.

On the other hand, the browser forms a standard software interface to the management unit, when the management unit itself does not have to take into consideration the special properties of the terminal type.

One of the properties of HMTL-language and other similar page description languages is the possibility to include sections separated with characters also known as tags into the page. These sections do not have to be understood by all of the applications processing the pages.

Now the management unit processes (in this example SQL-language) query sections enclosed with tags, transforms them into a form which can be understood by the browser and forwards the whole page in a form that the browser understands the structure and can present the page, e.g. in XML- or HTML-format.

The management unit can be generated so that it can combine certain parts of the structured page to certain queries directed to the database.

In addition, the management unit can attach the input data from the browser to the (SQL-language) query, and this way form complete (SQL-language) queries that can be transmitted directly to the database.

FIG. 3 presents also a server database 305 that is not in the terminal 301 or in its close proximity.

The server database 305 and the local database 303 forms a simple distributed database.

To make the data in these databases as consistent as possible, a synchronization method 304 is required.

From the inventions point of view it is not essential, what particular synchronization method will be used, as long as some arrangement of this kind exists.

A useful synchronization method is a server-client pair compatible with SyncML-protocol. A SyncML client would locate in the terminal or otherwise in communion of the local database 303. The SyncML server would locate in the communion of the server database 305.

SyncML client has database connection to terminal database (it's usually on same machine). On the server side SyncML server and database can also be in different machines, but those machines are connected to each other usually with TCP/IP protocol. So communion means basically that SyncML client/server has some kind of connection to database.

Next the initializing of the terminal is explained; this means loading the local database and the pages to be presented into the terminal memory.

Assume for example that the server database 305 includes information about home service company's clients and about the timetables of the company's employees.

In addition, the server database includes a programmable user interface of an employee. With this we mean the pages that are designed to fill the likes and needs of the employee.

Initialization means that the user connects to the server database with his terminal and enters a command. Due to this, part of the information in the server database 305 is copied to the local database 303.

The user can choose the amount of copied information according to his needs.

The information includes e.g. the programmable user interface of the user plus all the information, which involves the work schedule of the employee on that day and the clients he is supposed to visit.

Initialization means for example that we are able to use any terminal for the expression of information.

The user can initialize any equipment, that is equipped with a browser and then upload a desired user interface and information to his use.

It is possible to use a fixed terminal at the office. At the actual working destination, e.g. the work instructions can be conveniently retrieved to the portable display or the information can be downloaded to a mobile communicator.

The user updates the database during his work.

The employee can e.g. download the job instructions and daily tasks to his terminal and to mark the job as done in phases.

This way it is simple to control jobs occurring in different locations as a whole.

Work phases and work progress can be monitored in real time.

FIG. 4 presents a method, where the users terminal 401 can retrieve data also directly from the server database 405 or from some other server 409.

The databases 403,405,409 can all be SQL-based, but this is not an unconditional prerequisite from the inventions point of view: in principle, the management units 406,407, 408 can be designed so that besides SQL-queries they are able to form queries to any other data source.

The situation in FIG. 4 can come up when the user retrieves data to his terminal 401 from the local database.

Let us first assume that the user presents a request to the browser 402 with a known method, after which the management unit 406 transmits the query to the local database 403, as presented earlier.

The management unit 406 receives the results from the local database 403, and transforms it into a form understood by the browser 402.

Now the results retrieved to the display can include queries e.g. to the server database 405 or to some other servers database 409.

According to this method the presented page, which includes cross-references to external databases 405,409 will be created from the information retrieved from the local database.

Due to the user's input a connection to the management unit 407 of server database 405 is formed from the browser 402 or to the management unit 409 of an external server's database 409.

It is clear that in the method in FIG. 4 allows that the original pages may also include references to external databases.

With regard to the method in FIG. 4: connections to other than to the local database require generating a network connection as well, e.g. a TCP/IP-connection.

If a connection to the external management units 407,408 cannot be established, the required queries and information cannot be transmitted.

The use described above would be a big help e.g. for a freelance worker, who could load his current employers user environment with all the information and instructions included to

This way the employee is free to change the user environment and the employer anytime.

Simply uploading a new user environment to the users terminal does all this. No additional equipment is needed.

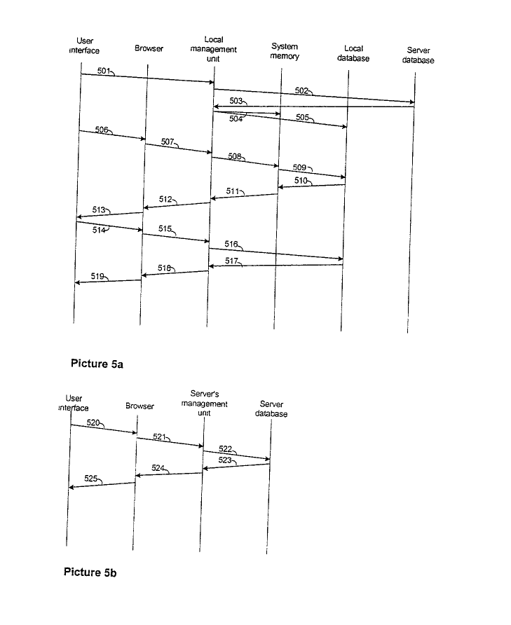

FIGS. 5a and 5b present how the equipment of inventions inexpensive method functions.

Let us examine FIG. 5a first.

On the account of the functioning, the system memory of the user's terminal, which includes a programmable user interface, e.g. presentable HTML-pages, and the local database, that includes merely database information, are detached from each other.

At first, when the user wishes to initialize a certain section of the database and a certain programmable user interface 501 to his use, the management unit retrieves the initialization information from the server database 502.

The results of query are transmitted to the management unit 503 that stores desired results to the memory 504 of the terminal system and to the local database 505.

In addition, the results are transmitted to the browser for monitoring in the user interface.

Now the user is able to choose a certain function, e.g. a list of clients that have to be visited on that day.

The user enters a starting command e.g. with keyboard or with a touch pen. The starting command is transmitted to browser 506 and furthermore to the management unit 507.

In this example, the management unit retrieves, on ground of the starting command an HTML/SQL-page from the system memory.

If needed, the information that is based on the query can be retrieved from a local database 509.

The page retrieved from the database can be saved to the system memory 510, from which the desired page is transmitted to the local management unit 511.

The management unit now transmits the page in HTML-format to browser 512, which transmits it to the display 513 for presentation.

The user has now a desired page view on his display that is in accordance with his personal user interface.

Next the user is able to retrieve, change, add or remove information.

The user enters an input data that the user interface transmits to browser 514. The browser transmits the input data further to management unit 515 that forms a SQL-query based on the input data. This query is then sent to local database 516.

The management unit receives the answers from database 517 and edits them to a form in which they can be directly presented for example in HTML-format.

The retrieved information in correct format is transmitted to browser 518, which transmits it to display 519 for presentation. After point 514, as the user has his individual user interface in his use, we may continue according to method presented in FIG. 5b.

In point 520 the input data of the user is transmitted from user interface to the browser.

The browser then transmits the input data of this method to the management unit of another server through a known network connection 521.

The management unit of the server transmits the query it has edited to the database 522 of the external server and receives the results 523.

Furthermore, the management unit of the server edits the results so that they are in a format accepted by a receiving browser and sends search results in correct format to browser 524, which transmits them to display 525 for presentation.

Further variations and modifications of the foregoing will be apparent to those skilled in the art and are intended to be encompassed by the claims appended hereto.

Finland priority application 20010724 is relied on and incorporated herein by reference.

We claim:

1. A method for utilizing information stored in distributed database with a terminal comprising:
utilizing a local database via a management unit;
transmitting query results from said local database through the management unit to a browser application in the terminal; and
presenting query information to the user with the browser application in the terminal.

2. A system for the use of distributed database in a terminal comprising:
a terminal including a browser application;
a local database in the immediate contiguity of the terminal and a management unit in order to process the local database to a appropriate format and to transmit the query results gained from database to the browser application; and
said browser application of the terminal being organized to present the query results gained from the database with the terminal.
